(19) United States
(12) Patent Application Publication
(10) Pub. No.: US 2006/0205479 A1
(43) Pub. Date: Sep. 14, 2006

(54) Gaming machine with transposed pay schedule

(76) Inventor: David B. Schultz, Henderson, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/077,611

(22) Filed: Mar. 11, 2005

(51) Int. Cl. A63F 13/00

(52) U.S. Cl. 463/20

(57) ABSTRACT

A gaming device includes a cabinet having a game display for a game, a first pay table designating winning combinations of symbols and corresponding payout values, and a second pay table designating winning combinations of symbols and corresponding payout values. The payout values of winning combinations in the second pay table are inverted as compared to the payout values for the winning combinations in the first pay table.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Many different types of gaming devices have developed over time to increase and captivate a player's interest in those gaming devices. For example, in some slot machines the display windows show more than one adjacent symbol on each reel, thereby allowing multiple row betting. Other types of slot machines have also been developed to increase player interest that include “second chance” games. Typically, “second chance” games try to maintain player interest from a first game segment to a second game segment by providing the player with another opportunity to win.

However, there is a continuing need for additional slot machine variants that provide a player with enhanced excitement and diversity of game play, without departing so far from the original slot machine gaming concept that player comfort is unacceptably diminished. Further, there is a continuing need for a gaming machine that provides increased player excitement. Accordingly, those skilled in the art have long recognized the need for a gaming machine that addresses these and other issues.

### SUMMARY

Briefly, and in general terms, various embodiments of a gaming machine disclosed herein are directed to gaming machines having a first pay table and a second pay table. The second pay table has payout values that are inverted as compared to the first pay table. Accordingly, those symbol combinations that resulted in the lowest payouts on the first pay table would have the highest payouts in the second pay table. And those symbol combinations having the highest payouts on the first pay table would have the lowest payouts in the second pay table. In another embodiment, the second pay table is inverted as compared the first pay table such that winning combinations are mirror images of one another. That is, in the first pay table, winning combination would be read left-to-right whereas winning combination in second pay table would be read “right-to-left.”

In one embodiment, the gaming machine includes a cabinet having a game display for a game and a pay table display for a standard pay table and a bonus pay table. In this embodiment, the bonus pay table is a transposed pay table. In another embodiment, the gaming machine includes a plurality of symbol-bearing reels, a first pay table designating winning combinations of symbols and corresponding payout values, and a second pay table designating winning combinations of symbols and corresponding payout values. In this embodiment, the payout values of winning combinations in the second pay table are inverted as compared to the payout values for the winning combinations in the first pay table.

In yet another embodiment, the gaming machine includes a cabinet having a game display for a game, a first pay table designating winning combinations of symbols and corresponding payout values, and a second pay table designating winning combinations of symbols and corresponding payout values. In this embodiment, the payout values of winning combinations in the second pay table are inverted as compared to the payout values for the winning combinations in the first pay table.

### BRIEF DESCRIPTION OF THE DRAWINGS

FIG. 1 illustrates the functional units for one embodiment of a gaming machine having a transposed pay table;

FIG. 2 is a front plan view of one embodiment of one embodiment of a gaming machine having a transposed pay table;

FIG. 3 is a flow diagram illustrating the basic steps carried out by a gaming machine;

FIG. 4 depicts another embodiment of the pay tables for a video poker game having a transposed pay table; and

FIG. 5 depicts yet another embodiment of the pay tables for a video keno game having a transposed pay table.

### DETAILED DESCRIPTION

Various embodiments disclosed herein are directed to a gaming machine having at least two pay tables, the second of which is inverted as compared to the first pay table. The transposed pay table is a bonus pay schedule that has inverted pay schedule as compared to the standard pay table. Accordingly, when the bonus game is triggered, those symbol combinations that resulted in the lowest payouts on the standard pay table have the highest payouts in the transposed pay table. Correspondingly, those symbol combinations having the highest payouts on the standard pay table have the lowest payouts in the transposed pay table.

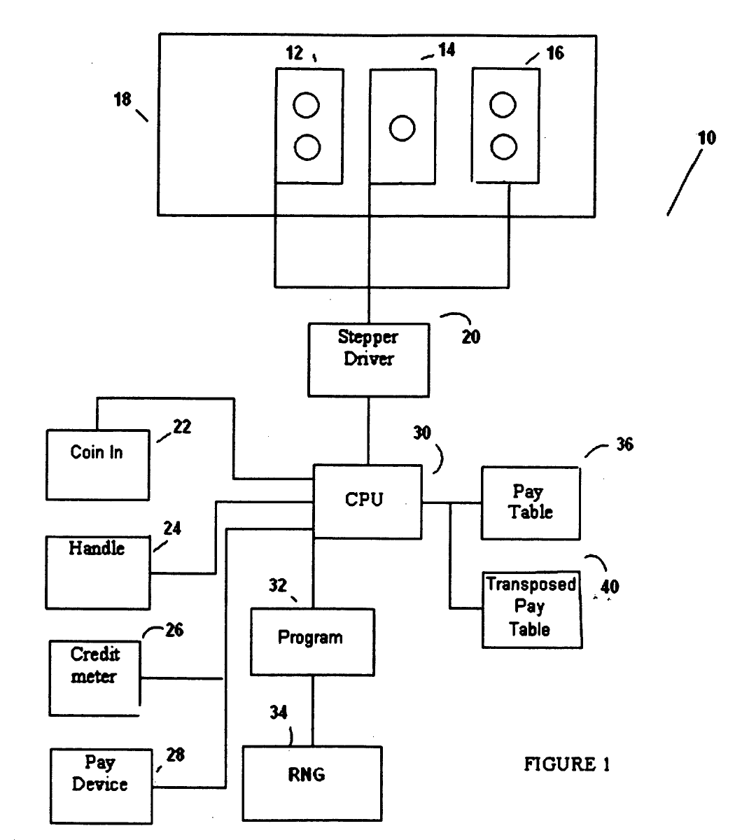

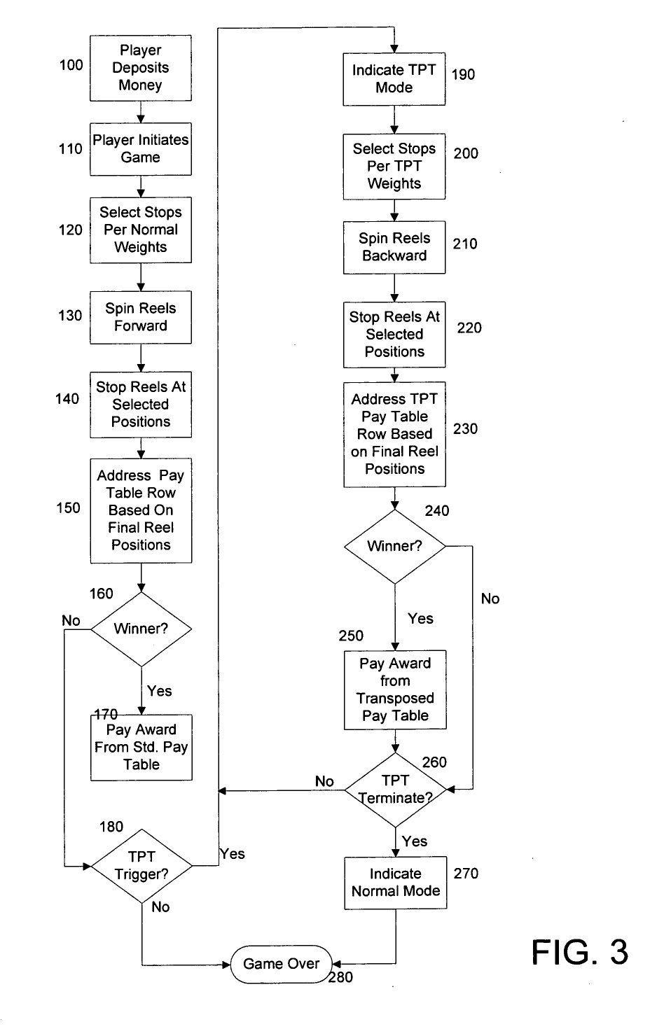

Referring now to the drawings, wherein like reference numerals denote like or corresponding parts throughout the drawings and, more particularly to FIGS. 1-5, there is shown various embodiments of a gaming machine 10 having a transposed pay table (TPT). Specifically, FIG. 1 illustrates the various functional units in a gaming machine 10 as well as the TPT. As those skilled in the art will appreciate, the gaming machine 10 can include a plurality of reels 12, 14, 16 housed in a display area 18, a CPU 30, a stepper driver 20, a random number generator (RNG) 34, a program ROM 32, a money detector 22, a handle 24, a TPT ROM 40, a pay table ROM 36, a payout mechanism 28, and a credit display 26. Of course, one of ordinary skill in the art will appreciate that not all gaming machines 10 will have all these components, and may indeed, have other components in addition to or in view of those components mentioned here.

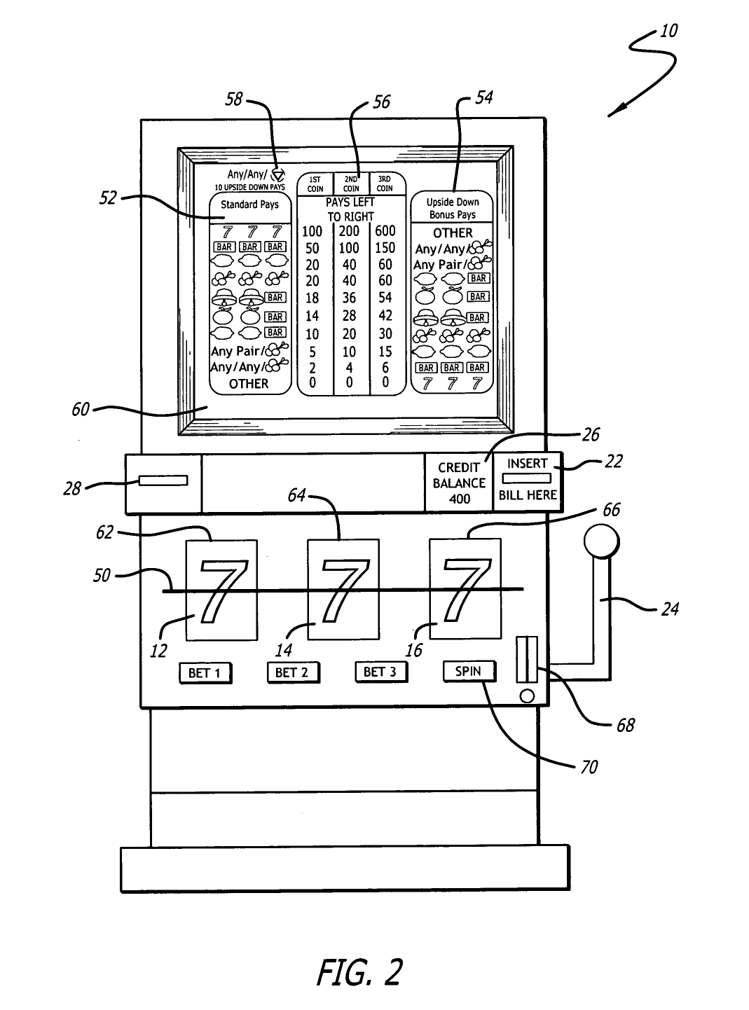

FIG. 2 shows a representation of a gaming machine 10 having a standard pay table 52 and a transposed pay table 54 printed on a display glass. In another embodiment, the transposed and standard pay tables 52, 54 may be displaced on a video screen. The standard pay table 52 lists the winning symbol combinations and the corresponding payout values in an adjacent pay table 56. In the embodiment shown in FIG. 2, the payout values in the pay table 56 are for one to three coins wagered by the player. As those skilled in the art will appreciate, the payout table may list payout values for only one or two coins or for three plus coins.

In one embodiment, the TPT portion 54 of the pay table is also displayed on the pay glass 60. As shown in FIG. 2, the winning symbol combinations are the same for both the standard pay table 52 and the transposed pay table 54. However, the payout values for the winning symbol combinations for TPT portion are inverted as compared to the standard pay table 52. That is, the transposed pay table 54 differs from the standard pay table 52 such that the pay out values for the lowest symbol combination in the standard pay table pay the most in the transposed pay table. For instance, in the standard pay table, “7 7 7” pays 100, 200, or 600 coins in the standard game whereas “7 7 7” pays no coins in the TPT mode of the game.

In another embodiment, the transposed pay table 54 differs from the standard pay table 52 in that pay out values in the transposed pay table apply to symbol combinations that are opposite in order as compared the standard pay table. That is, winning combinations are generally read from left to right in a standard game. In the TPT game mode, the winning symbol combinations are reversed such that the winning combinations “read” right to left. For instance, as shown in FIG. 2, the standard table pays out coins for a “bell-bell-bar” symbol combination, and the winning combination would be “bar-bell-bell” in the TPT game mode.

In one embodiment, when the TPT game mode is triggered, the TPT portion 54 of the pay glass 60 is illuminated to signal to a player any winnings will be paid according to the transposed pay table 54. In another embodiment, the transposed pay table 54 is illuminated and the standard pay table 52 would be dimmed. In yet another embodiment, a single bonus mode lamp is illuminated to designate that any winnings are to be paid according to the transposed pay table 54. In another embodiment, the use of a reverse reel spin in TPT mode may signal to the player that any winning combinations will be paid according to transposed pay table. That is, if the reels spin from top-to-bottom in the base game, the reels will spin from bottom-to-top in a TPT mode of the game. In those embodiments having a video display, the transposed pay table 54 is highlighted on the screen. Alternatively, the transposed pay table 54 may only be displayed.

As shown in FIG. 2, each reel 12, 14, 16 has a variety of symbols printed on its periphery. As those skilled in the art will appreciate, the symbols may be any image and may even be a blank space. As shown in FIG. 2, the gaming machine is shown with three reels, however in alternate embodiments, there may be more or less than three reels. In one embodiment, the reels 12, 14, 16 are displayed through individual display windows 62, 64, 66. In an alternate embodiment, the reels 12, 14, 16 are displayed through a single display window. Also, as illustrated in FIG. 2, a pay line 50 is printed on the display glass of the gaming machine 10. In alternate embodiments, the gaming machine 10 has one or more pay lines 50 printed on the display glass. In another embodiment, the reels are electronically represented on a video display such as, but not limited to, a CRT or flat screen display. In this embodiment, the gaming machine 10 may include one or more electronic pay lines for video-based gaming machines.

In one embodiment of the gaming machine 10, the stopping positions of the reels 12, 14, 16 are predetermined using a random number generator (RNG) 34 that includes a random number generator program contained within the program ROM 32 (or other suitable location) that is executed by the CPU 30. In one embodiment, the RNG 34 is any pseudo-random number generator or a weighted RNG program.

With respect to the weighted RNG program, the program is configured such that the probability of each possible outcome is not equal. In one embodiment, the weighted RNG program is configured so there is a higher probability paying out small award amounts as compared to higher award amounts in a base game. In another embodiment, the probability weights assigned to the symbols on each of the reels during the bonus mode may or may not be different than the weights assigned to the same symbols during regular game play, reducing both the probability that the player will receive the highest pay for a frequently occurring symbol combination and the probability that the player will receive the less frequently occurring symbol combinations and be awarded below average awards during bonus play. Accordingly, the weighted RNG for determining a pay value can be used to achieve any desired average pay value regardless of the number of winning symbol combinations in the physical pay glass 60.

In one method for implementing a weighted RNG 34, numbers are assigned to each possible pay value, with more numbers having assigned to the lower value pay values. Accordingly, a random number generator will have a higher likelihood of selecting a number assigned to a lower value than selecting a number assigned to a high value.

As shown in FIG. 1, the RNG 34 is shown separately from the program ROM 32, but the RNG may be contained with the program ROM. In other embodiments, the ROM 32 (or other memory device) also contains the instructions for carrying out the game. In another embodiment, the ROM 32 is a programmable ROM. With a programmable ROM, the operating program and the award program in the pay table ROM 36 are easily modified to provide variations on the game or pay outs in the game.

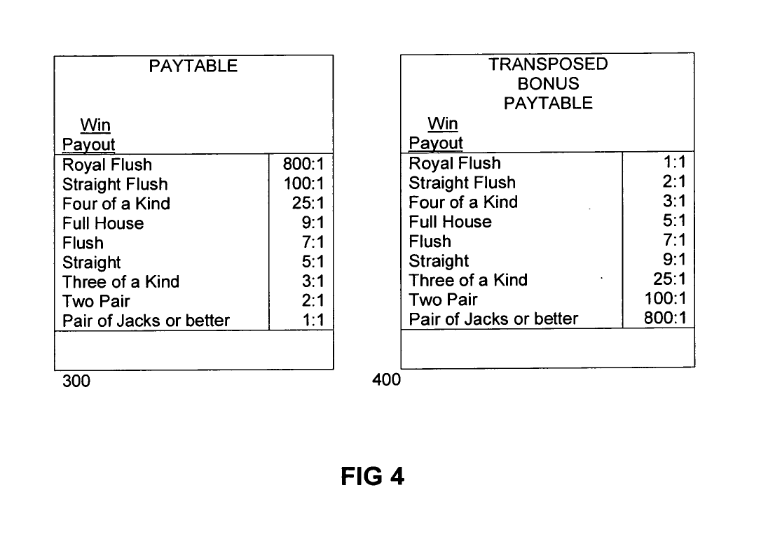

Turning now to FIG. 4, in step 100, a coin is deposited through slot 68. In another embodiment, paper currency or vouchers are inserted into a paper currency slot and reader 22. Once the gaming machine detects a wager, the player initiates the game by pulling a handle 24 or the pressing of button 70 as indicated in step 110.

In step 120, the CPU 30, under control of the program ROM 32, uses a random number generator 34 to select the final reel positions for reels 12, 14, 16. The CPU 30 causes pulses to be issued to the stepper motors 20 causing rotation of the reels 12, 14, 16 as indicated at step 130. In one embodiment, the reels 12, 14, 16 spin in a forward (top-to-bottom) direction during play of the base game. In another embodiment, the reels 12, 14, 16 spin in a backward (bottom-to-top) direction during play of the base game. In other embodiments, the reels 12, 14, 16 spin in a “crazy spin” mode in which each reel spins independently in a random direction.

The CPU 30 issues the required number of pulses to stepper motors 16 in order to cause the reels 12, 14, 16 to stop at their predetermined stop positions, as shown in step 140 in FIG. 4. In one embodiment, each of the reels 12, 14, 16 is driven by a separate stepper motor 16 that rotates in response to signals from a CPU 30. In another embodiment, a driver 20 issues pulses to motors to rotate as commanded by CPU 30. The number of pulses delivered to each stepper motor determines the stopping positions of the reels 12, 14, 16. In step 140 of FIG. 4, the reels are stopped at their selected positions.

Once the reels are stopped at their selected positions, the CPU 30 addresses the pay table ROM 36 based on the final reel positions as shown in step 150, and the CPU 30 determines if the selected combination of symbols is a winning combination, as shown in step 160. If the selected combination of symbols is not a winning combination, no pay is awarded and the program instructs the CPU 30 to step 180. If the selected combination of symbols is a winning combination, the program instructs CPU 30 to pay the winnings based on the winning combination of symbols as specified in pay table ROM 36, as shown in step 170. Accordingly, the CPU 30 activates the payout mechanism 28 to pay the player. Alternatively, credit display 26 may be incremented by the appropriate number of credits or an escrow win meter (not shown) may be incremented for payment reconciliation at the end of the game.

In one embodiment, the program contained in program ROM 32 also controls the gaming machine 10 to determine if one or more transposed pay table (TPT) triggers 58 are included in the winning combination, as shown in step 180. If a TPT trigger 58 is not included, the program instructs CPU 30 to end the game as shown in step 280. If a TPT trigger 58 is present, the program enters a TPT mode as shown is steps 190-260. In another embodiment, no special symbol 58 is needed to initiate the TPT mode. The activation of the TPT bonus mode in any of the embodiments described herein may be initiated upon any event. The TPT mode may be activated by events such as, but not limited to, the playing a predetermined number of games, a random time or randomly selected number of games, a predetermined symbol combination(s), display of a special symbol, number of maximum bets wagered, playing the maximum number of pay lines, particular total wager amount, or a combination thereof.

Once the reels are stopped at their selected positions, CPU 30 addresses pay table ROM 40 based on the final reel positions, as shown in step 230, to determine if the selected combination of symbols is a winning combination, as shown in step 240 of FIG. 4. In some embodiments, the pay table ROM 36 and the TPT ROM 40 may be incorporated into a single ROM device or other functionally similar memory implementation. If the selected combination of symbols is not a winning combination, no pay is awarded and flow skips to step 260. If the selected combination of symbols is a winning combination, the program instructs CPU 30 to pay the winnings based on the winning combination of symbols as specified in pay table ROM 40, as shown in step 250. Accordingly, the CPU 30 may activate payout mechanism 28 to pay the player. Alternatively, credit display 26 may be incremented by the appropriate number of credits or an escrow bonus meter (not shown) may be incremented for payment reconciliation at the end of the game.

The program contained in program ROM 32 also controls the machine to determine if TPT mode should be terminated as shown in step 260. The termination of the TPT mode in any of the embodiments described herein may occur upon any event. Examples include termination of the TPT mode based upon: the number of bonus games played reaching a predetermined number, a random time or randomly selected number of TPT games, a symbol combination(s) being obtained, a special symbol being displayed, or any other event. If TPT mode should not be terminated, the program instructs CPU 30 to return to step 200 to initiate another bonus game, as shown in step 260.

If TPT mode should be terminated, the program reverts to normal mode as shown in step 270. Normal mode may be indicated by highlighting the normal portion 52 of the pay glass 60 by, for example, illuminating this section of the pay glass and dimming the TPT portion 54 of the pay glass. Other methods for displaying whether the game is in normal or TPT mode such as a single bonus mode lamp are known in the art. It should be noted that in a video embodiment, a normal area of the pay table may be highlighted on the screen or the pay table may be displayed to show only the normal non-transposed pay schedule.

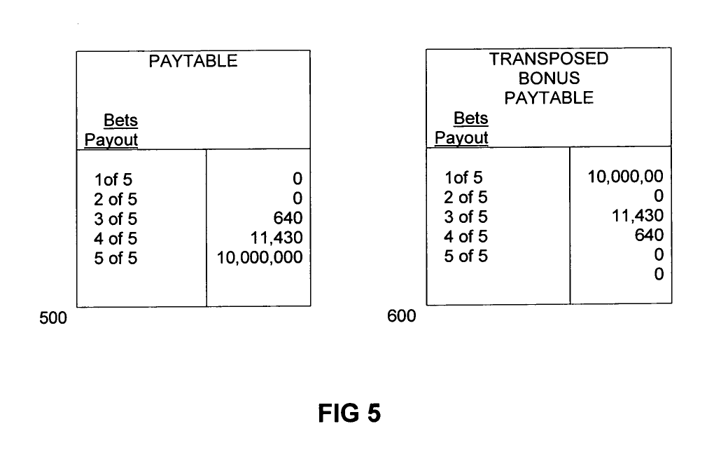

In alternate embodiments, the transposed pay table 54 is incorporated into any gaming machine 10 that makes use of ordered pay tables such as slots, poker, keno, or combinations thereof. As those skilled in the art will appreciate, the transposed pay table 54 may be used as part of the primary game or as a bonus game. For example, a video poker game may offer one or more special TPT bonus pay 400 following the occurrence of a 4-of-a-kind game outcome paid according to a normal pay schedule 300. (FIG. 5.) A keno game might have a normal pay schedule 500 (FIG. 6) but could have any type of bonus trigger such as a special bonus ball that would enable pay values according to a TPT schedule 600 on that or any number of subsequent games.

In use, a player inserts coins, bills, or vouchers to initiate play. In one embodiment, the player deposits one or more coins to activate a pay line. In another embodiment, the player deposits one or more coins to activate one or more pay lines. A money detector 22, which may detect coins or other currency, issues a command to the CPU 30 that the gaming machine 10 is ready to be played. The player selects wagers and initiates the game by pulling a handle 24 or pushing a “spin” button 70. After the CPU 30 determines the final stop positions and the reels have stopped, the stop positions are then applied to a pay table ROM 36, which cross-references the final displayed symbols (or reel stop positions) with a monetary payout to the player. In one method, the TPT feature is implemented such that one or more games subsequent to an initiating game are free bonus games played in TPT mode until some terminating condition such as an expired bonus game counter or a particular symbol combination returns the game to normal mode. This payout is then conveyed to a payout mechanism 28 that issues coins, credits, or a voucher to the player.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming device, comprising:
a cabinet having a game display for a game; and
a pay table display including a standard pay table and a bonus pay table, wherein the bonus pay table is a transposed pay table as compared to the standard pay table.

2. The gaming device of claim 1, wherein the pay table display is one or more video screens, one or more display glasses, or a combination thereof.

3. The gaming device of claim 1, wherein the transposed pay table comprises winning combinations that are inverted as compared to winning combinations for the standard pay table.

4. The gaming device of claim 1, wherein the transposed pay table comprises winning combinations that are reversed as compared to winning combinations for the standard pay table.

5. The gaming device of claim 1, wherein the gaming device further comprises one or more reels, wherein the reels are mechanical reels, video components, or a combination thereof.

6. The gaming device of claim 5, wherein the game has one or more pay lines.

7. The gaming device of claim 6, wherein the game has a primary game and a bonus game.

8. The gaming device of claim 7, wherein the reels spin in a top-to-bottom orientation in the primary game.

9. The gaming device of claim 8, wherein the reels spin in a bottom-to-top orientation or a random orientation in the bonus game.

10. The gaming device of claim 8, wherein the reels spin in a random orientation in the bonus game.

11. The gaming device of claim 7, wherein the standard pay table is illuminated during play of the primary game.

12. The gaming device of claim 7, wherein the bonus pay table is illuminated during play of the bonus game.

13. The gaming device of claim 1, wherein the game is slots, poker, keno, or a combination thereof.

14. A gaming device, comprising:
a plurality of reels having symbols thereon;
a first pay table designating winning combinations of the symbols and corresponding payout values; and
a second pay table designating winning combinations of the symbols and corresponding payout values, wherein payout values of winning combinations in the second pay table are inverted as compared to the payout values for the winning combinations in the first pay table.

15. The gaming device of claim 14, further comprising one or more pay lines.

16. The gaming device of claim 14, wherein the reels are mechanical reels, video components, or a combination thereof.

17. The gaming device of claim 14, wherein the first pay table and the second pay table are displayed on one or more video screens, one or more display glasses, or a combination thereof.

18. The gaming device of claim 14, wherein the first pay table is illuminated during play of a primary game.

19. The gaming device of claim 14, wherein the second pay table is illuminated during play of a secondary game or a bonus game.

20. The gaming device of claim 14, wherein the reels spin in a top-to-bottom orientation in a game using the first pay table.

21. The gaming device of claim 14, wherein the reels spin in a bottom-to-top orientation in a game using the second pay table.

22. The gaming device of claim 14, wherein the reels spin in a random orientation in a game using the second pay table.

23. A gaming device, comprising:
a gaming presentation;
a first pay table designating winning combinations of the symbols and corresponding payout values; and
a second pay table designating winning combinations of the symbols and corresponding payout values, wherein payout values of winning combinations the second pay table are inverted as compared to the payout values for the winning combinations in the first pay table.

24. A gaming device, comprising:
a gaming presentation; and
a pay table display including a first pay table and a second pay table, each pay table containing payout values, wherein second first pay table includes payout values that are transposed in comparison to the payout values of the first pay table.
